(19) United States
(12) Patent Application Publication
(10) Pub. No.: US 2017/0026930 A1
(43) Pub. Date: Jan. 26, 2017

(54) LOCALIZATION APPARATUS AND LOCALIZATION METHOD

(71) Applicant: FUJITSU LIMITED, Kawasaki-shi (JP)

(72) Inventors: Pei CHEN, Beijing (CN); Jianmin ZHOU, Beijing (CN)

(21) Appl. No.: 15/216,253

(22) Filed: Jul. 21, 2016

(30) Foreign Application Priority Data
Jul. 23, 2015 (CN) 201510437007.4

(51) Int. Cl. H04W 64/00; H04W 8/00

(52) U.S. Cl. CPC H04W 64/006; H04W 8/005

(57) ABSTRACT

Embodiments of the present disclosure provide a localization apparatus and localization method. Positioning of the target terminal may be achieved without needing to preobtain a location of a terminal used for cooperative localization, and selection of the terminal used for cooperative localization according to the geometric distribution may efficiently improve the precision of the localization of the target terminal.

### TECHNICAL FIELD

The present disclosure relates to the field of communications, and in particular to a localization apparatus and localization method.

### BACKGROUND

In a modern communication system, such as a cellular network, and a wireless sensor network, etc., localization services and location-aware techniques become more and more important. A localization technique may be divided into two methods, one is ranging-based, and the other one is ranging-free. The localization method based on ranging includes observation of a time of arrival (TOA), a time difference of arrival (TDOA) and a direction of arrival (DOA), which is advantageous in wide coverage and high precision over the ranging-free localization method. However, the ranging-based localization method requires that line of sight (LOS) observation may be performed between a base station and a terminal. While in a practical communication system, as there exist many obstructions between a base station and a terminal, a direct measurement of a distance between the base station and the terminal becomes difficult.

Currently, this problem may be solved by introducing a cooperation mechanism. When the number of base stations on which LOS observation may be performed by a target terminal is less than a required number, a cooperative terminal is selected as a virtual base station, to jointly complete localization of the target terminal based on a location of the cooperative terminal and locations of the base stations.

It should be noted that the above description of the background is merely provided for clear and complete explanation of the present disclosure and for easy understanding by those skilled in the art. And it should not be understood that the above technical solution is known to those skilled in the art as it is described in the background of the present disclosure.

### SUMMARY

In using an existing method for cooperative localization, a location of a terminal used for the cooperative localization needs to be preobtained. And a terminal having a maximum number of base stations on which LOS observation is capable of being performed is generally selected as a terminal used for cooperative localization, in which geometric distribution of the terminal, a target terminal and the base stations is not taken into account. When the geometric distribution constituted by the terminal selected for cooperative localization, the target terminal and base stations on which LOS observation is capable of being performed is unideal, precision of the localization of the target terminal will be obviously lowered.

Embodiments of the present disclosure provide a localization apparatus and localization method, in which localization of the target terminal may be achieved without needing to preobtain a location of a terminal used for cooperative localization, and selection of the terminal used for cooperative localization according to the geometric distribution may efficiently improve the precision of the localization of the target terminal.

According to a first aspect of embodiments of the present disclosure, there is provided a localization apparatus, including: a determining unit configured to determine terminals capable of performing LOS observation with a target terminal; a selecting unit configured to select at least one terminal from the terminals capable of performing LOS observation with the target terminal, so that a geometric distribution constituted by the selected at least one terminal, base stations on which LOS observation is capable of being performed by the at least one terminal, the target terminal and base stations on which LOS observation is capable of being performed by the target terminal, satisfies a predetermined condition; and a first calculating unit configured to obtain location information on the target terminal and the selected at least one terminal by using a localization solution algorithm according to information on the selected at least one terminal, the base stations on which LOS observation is capable of being performed by the at least one terminal, the target terminal and the base stations on which LOS observation is capable of being performed by the target terminal.

According to a second aspect of embodiments of the present disclosure, there is provided electronic equipment, including the localization apparatus as described in the first aspect of embodiments of the present disclosure.

According to a third aspect of embodiments of the present disclosure, there is provided a localization method, including: determining terminals capable of performing LOS observation with a target terminal; selecting at least one terminal from the terminals capable of performing LOS observation with the target terminal, so that a geometric distribution constituted by the selected at least one terminal, base stations on which LOS observation is capable of being performed by the at least one terminal, the target terminal and base stations on which LOS observation is capable of being performed by the target terminal, satisfies a predetermined condition; and obtaining location information on the target terminal and the selected at least one terminal by using a localization solution algorithm according to information on the selected at least one terminal, the base stations on which LOS observation is capable of being performed by the at least one terminal, the target terminal and the base stations on which LOS observation is capable of being performed by the target terminal.

An advantage of embodiments of the present disclosure exists in that localization of the target terminal may be achieved without needing to preobtain a location of a terminal used for cooperative localization, and selection of the terminal used for cooperative localization according to the geometric distribution may efficiently improve the precision of the localization of the target terminal.

With reference to the following description and drawings, the particular embodiments of the present disclosure are disclosed in detail, and the principle of the present disclosure and the manners of use are indicated. It should be understood that the scope of embodiments of the present disclosure is not limited thereto. Embodiments of the present disclosure contain many alternations, modifications and equivalents within the scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “comprises/comprising/includes/including” when used in this specification is taken to specify the presence of stated features, integers, steps or components but does not preclude the presence or addition of one or more other features, integers, steps, components or groups thereof.

### BRIEF DESCRIPTION OF THE DRAWINGS

The drawings are included to provide further understanding of the present disclosure, which constitute a part of the specification and illustrate the preferred embodiments of the present disclosure, and are used for setting forth the principles of the present disclosure together with the description. It is obvious that the accompanying drawings in the following description are some embodiments of the present disclosure only, and a person of ordinary skill in the art may obtain other accompanying drawings according to these accompanying drawings without making an inventive effort. In the drawings:

FIG. 1 is a schematic diagram of a structure of the localization apparatus of Embodiment 1 of the present disclosure;

FIG. 2 is a schematic diagram of geometric distribution constituted by a terminal MS_LOS0, a target terminal MSk and base stations on which LOS observation is capable of being performed of Embodiment 1 of the present disclosure;

FIG. 3 is another schematic diagram of the geometric distribution constituted by the terminal MS_LOS0, the target terminal MSk and the base stations on which LOS observation is capable of being performed of Embodiment 1 of the present disclosure;

FIG. 4 is a schematic diagram of geometric distribution constituted by terminals MS_LOS1 and MS_LOS2, the target terminal MSk and the base stations on which LOS observation is capable of being performed of Embodiment 1 of the present disclosure;

FIG. 5 is a schematic diagram of a structure of the electronic equipment of Embodiment 2 of the present disclosure;

FIG. 6 is a block diagram of a systematic structure of the electronic equipment of Embodiment 2 of the present disclosure;

FIG. 7 is a flowchart of the localization method of Embodiment 3 of the present disclosure; and

FIG. 8 is a flowchart of the localization method of Embodiment 4 of the present disclosure.

### DETAILED DESCRIPTION DISCLOSURE

These and further aspects and features of the present disclosure will be apparent with reference to the following description and attached drawings. In the description and drawings, particular embodiments of the disclosure have been disclosed in detail as being indicative of some of the ways in which the principles of the disclosure may be employed, but it is understood that the disclosure is not limited correspondingly in scope. Rather, the disclosure includes all changes, modifications and equivalents coming within the terms of the appended claims.

### Embodiment 1

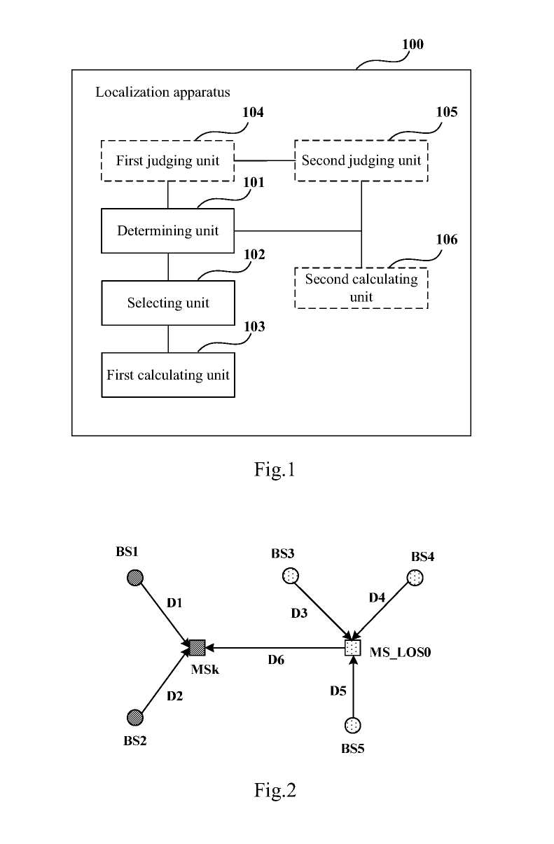

FIG. 1 is a schematic diagram of a structure of the localization apparatus of Embodiment 1 of the present disclosure. As shown in FIG. 1, the apparatus 100 includes:

a determining unit 101 configured to determine terminals capable of performing LOS observation with a target terminal;

a selecting unit 102 configured to select at least one terminal from the terminals capable of performing LOS observation with the target terminal, so that a geometric distribution constituted by the selected at least one terminal, base stations on which LOS observation is capable of being performed by the at least one terminal, the target terminal and base stations on which LOS observation is capable of being performed by the target terminal, satisfies a predetermined condition; and

a first calculating unit 103 configured to obtain location information on the target terminal and the selected at least one terminal by using a localization solution algorithm according to information on the selected at least one terminal, the base stations on which LOS observation is capable of being performed by the at least one terminal, the target terminal and the base stations on which LOS observation is capable of being performed by the target terminal.

It can be seen from the above embodiment that localization of the target terminal may be achieved without needing to preobtain a location of a terminal used for cooperative localization, and selection of the terminal used for cooperative localization according to the geometric distribution may efficiently improve the precision of the localization of the target terminal.

In this embodiment, the determining unit 101 is configured to determine the terminals capable of performing LOS observation with the target terminal. For example, an existing method may be used to determine the terminals capable of performing LOS observation with the target terminal.

For example, in measuring a time of arrival (TOA), or a propagation channel feature h(t), etc., between the target terminal and a terminal that can be observed, a terminal in other observed terminals capable of performing LOS observation with the target terminal is judged based on measurement variance of the TOA or a kurtosis coefficient of the propagation channel feature h(t) between the target terminal and the other terminals by using an existing assumption detection method. For example, there are four terminals on which LOS observation is capable of being performed by the target terminal MSk, which are denoted by MS_LOS0, MS_LOS1, MS_LOS2 and MS_LOS3, respectively.

In this embodiment, information interacted between the target terminal and the terminals capable of performing LOS observation with the target terminal includes at least one piece of the following information: information on base stations on which LOS observation is capable of being performed, coordinates of the base stations, observation information on a time of arrival (TOA) between the base stations and the terminals, location information on available terminals, information on terminals on which LOS observation is capable of being performed, ID information on terminals, and observation information on a TOA between terminals.

In this embodiment, the selecting unit 102 is configured to select at least one terminal from the terminals capable of performing LOS observation with the target terminal, so that the geometric distribution constituted by the selected at least one terminal, the base stations on which LOS observation is capable of being performed by the at least one terminal, the target terminal and the base stations on which LOS observation is capable of being performed by the target terminal, satisfies the predetermined condition.

In this embodiment, the predetermined condition may be set according to an actual situation. For example, the predetermined condition is: geometric dilution of precision (GDOP) of the geometric distribution constituted by the selected at least one terminal, the base stations on which LOS observation is capable of being performed by the at least one terminal, the target terminal and the base stations on which LOS observation is capable of being performed by the target terminal is less than a predetermined first threshold value. In this embodiment, the predetermined first threshold value may be set according to an actual situation. For example, the predetermined first threshold value may be set to be a numeral value selected from 2-3.

For example, the predetermined condition may also be that a parameter related to the GDOP is less than a predetermined threshold value, or a volume of a polyhedron constituted by connecting unit direction vector end points of the at least one terminal, the base stations on which LOS observation is capable of being performed by the at least one terminal, the target terminal and the base stations on which LOS observation is capable of being performed by the target terminal, satisfies a predetermined condition.

In this embodiment, the selecting unit 102 may judge in a descending order of the number of the base stations on which LOS observation is capable of being performed by the terminals whether the geometric distribution constituted by the terminal, the base stations on which LOS observation is capable of being performed by the terminal, the target terminal and the base stations on which LOS observation is capable of being performed by the target terminal satisfies the predetermined condition, and take a terminal satisfying the predetermined condition as the selected at least one terminal.

In this embodiment, the number of the base stations on which LOS observation is capable of being performed by the terminal may be obtained by using an existing method. For example, in measuring a TOA, or a propagation channel feature h(t), etc., between the target terminal and the base stations, a base station in other observed base stations capable of performing LOS observation with the terminal is judged based on measurement variance of the TOA or a kurtosis coefficient of the propagation channel feature h(t) between the terminal and the other base stations by using an existing assumption detection method.

In this embodiment, after the number of the base stations on which LOS observation may be performed by the target terminal and neighboring terminals is obtained, the number of the base stations on which LOS observation may be performed by the neighboring terminals is selected in a descending order, and take a terminal satisfying the predetermined condition as the selected at least one terminal.

For example, the terminals on which LOS observation may be performed by the target terminal MSk are MS_LOS0, MS_LOS1, MS_LOS2 and MS_LOS3. For example, the number of the base stations on which LOS observation may be performed by MS_LOS0 is 3, the number of the base stations on which LOS observation may be performed by MS_LOS1 and MS_LOS2 is 2, and the number of the base stations on which LOS observation may be performed by MS_LOS3 is 1.

In this embodiment, screening is performed according to the number of the base stations on which LOS observation is capable of being performed in a descending order, and the terminal MS_LOS0 is taken as the selected terminal when the geometric distribution constituted by the target terminal MSk, the terminal MS_LOS0 and the base stations on which LOS observation may be performed by the target terminal MSk and the terminal MS_LOS0, satisfies the predetermined condition; the terminal MS_LOS0 is not taken as the selected terminal when the geometric distribution constituted by the target terminal MSk, the terminal MS_LOS0 and the base stations on which LOS observation may be performed by the target terminal MSk and the terminal MS_LOS0, does not satisfy the predetermined condition, and it is proceeded with judging whether the geometric distribution constituted by the target terminal MSk, the terminals MS_LOS1 and MS_LOS2 and the base stations on which LOS observation may be performed by the target terminal MSk and the terminals MS_LOS1 and MS_LOS2 can satisfy the predetermined condition.

FIG. 2 is a schematic diagram of the geometric distribution constituted by the terminal MS_LOS0, the target terminal MSk and the base stations on which LOS observation is capable of being performed of Embodiment 1 of the present disclosure. As shown in FIG. 2, the base stations on which LOS observation is capable of being performed by the target terminal MSk are BS1 and BS2, and the base stations on which LOS observation is capable of being performed by the terminal MS_LOS0 are BS3, BS4 and BS5. For example, geometric distribution constituted by the terminal MS_LOS0, the target terminal MSk and the base stations BS1-BS5 can satisfy the predetermined condition, and the terminal MS_LOS0 is taken as the selected terminal.

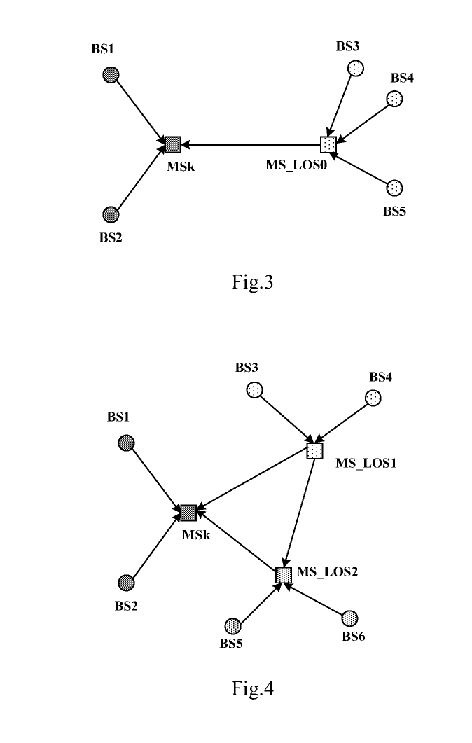

FIG. 3 is another schematic diagram of the geometric distribution constituted by the terminal MS_LOS0, the target terminal MSk and the base stations on which LOS observation is capable of being performed of Embodiment 1 of the present disclosure. As shown in FIG. 3, the base stations on which LOS observation is capable of being performed by the target terminal MSk are BS1 and BS2, and the base stations on which LOS observation is capable of being performed by the terminal MS_LOS0 are BS3, BS4 and BS5; however, the geometric distribution constituted by the terminal MS_LOS0, the target terminal MSk and the base stations BS1-BS5 does not satisfy the predetermined condition, and the terminal MS_LOS0 is not taken as the selected terminal.

FIG. 4 is a schematic diagram of geometric distribution constituted by the terminals MS_LOS1 and MS_LOS2, the target terminal MSk and the base stations on which LOS observation is capable of being performed of Embodiment 1 of the present disclosure. As shown in FIG. 4, the base stations on which LOS observation is capable of being performed by the target terminal MSk are BS1 and BS2, the base stations on which LOS observation is capable of being performed by the terminal MS_LOS1 are BS3 and BS4, and the base stations on which LOS observation is capable of being performed by the terminal MS_LOS2 are BS5 and BS6. For example, geometric distribution constituted by the terminals MS_LOS1 and MS_LOS2, the target terminal MSk and the base stations BS1-BS6 can satisfy the predetermined condition, and the terminals MS_LOS1 and MS_LOS2 are taken as the selected terminals.

In this embodiment, description is given based on the geometric distribution shown in FIG. 2 taking that the predetermined condition is the GDOP is less than the predetermined first threshold value as an example.

As shown in FIG. 2, the base stations on which LOS observation is capable of being performed by the target terminal MSk are BS1 and BS2, and the base stations on which LOS observation is capable of being performed by the terminal MS_LOS0 are BS3, BS4 and BS5, a distance between the base station BS1 and the target terminal MSk is D1, a distance between the base station BS2 and the target terminal MSk is D2, a distance between the base station BS3 and the terminal MS_LOS0 is D3, a distance between the base station BS4 and the terminal MS_LOS0 is D4, a distance between the base station BS5 and the terminal MS_LOS0 is D5, and a distance between the terminal MS_LOS0 and the target terminal MSk is D6.

In this embodiment, the above distances D1-D6 may be calculated according to Formula (1) below:

D₁=\sqrt{(x₁−xᵤ)²+(y₁−yᵤ)²+(z₁−zᵤ)²}

D₂=\sqrt{(x₂−xᵤ)²+(y₂−yᵤ)²+(z₂−zᵤ)²}

D₃=\sqrt{(x₃−xᵤ_{_}ₗₒₛ₀)²+(y₃−yᵤ_{_}ₗₒₛ₀)²+(z₃−zᵤ_{_}ₗₒₛ₀)²}

D₄=\sqrt{(x₄−xᵤ_{_}ₗₒₛ₀)²+(y₄−yᵤ_{_}ₗₒₛ₀)²+(z₄−zᵤ_{_}ₗₒₛ₀)²}

D₅=\sqrt{(x₅−xᵤ_{_}ₗₒₛ₀)²+(y₅−yᵤ_{_}ₗₒₛ₀)²+(z₅−zᵤ_{_}ₗₒₛ₀)²}

D₆=\sqrt{(xᵤ−xᵤ_{_}ₗₒₛ₀)²+(yᵤ−yᵤ_{_}ₗₒₛ₀)²+(zᵤ−zᵤ_{_}ₗₒₛ₀)²} (1);

where, x₁, x₂, x₃ and x₄, x₅ respectively denote coordinates of the base stations BS1, BS2, BS3, BS4 and BS5 in the x direction, y₁, y₂, y₃, y₄ and y₅ respectively denote coordinates of the base stations BS1, BS2, BS3, BS4 and BS5 in the y direction, xᵤ, yᵤ and zᵤ respectively denote coordinates of the target terminal MSk in the x, y and z directions, and xᵤ_{_}ₗₒₛ₀, yᵤ_{_}ₗₒₛ₀ and zᵤ_{_}ₗₒₛ₀ respectively denote coordinates of the terminal MS_LOS0 in the x, y and z directions.

In this embodiment, the GDOP of the geometric distribution constituted by the terminal MS_LOS0, the target terminal MSk and the base stations BS1-BS5 may be calculated according to Formula (2) below:

Co_GDOP=\sqrt{trace(H^{T}H)⁻¹} (2);

where, Co_GDOP denotes the GDOP of the geometric distribution constituted by the target terminal MSk and the base stations BS1-BS5, and the H matrix may be calculated according to Formula (3) below:

$$H = [ \begin{matrix}\frac{\partial {D}_{1}}{\partial {x}_{u}} & \frac{\partial {D}_{1}}{\partial {y}_{u}} & \frac{\partial {D}_{1}}{\partial {z}_{u}} & \frac{\partial {D}_{1}}{\partial {x}_{u\_los 0}} & \frac{\partial {D}_{1}}{\partial {y}_{u\_los 0}} & \frac{\partial {D}_{1}}{\partial {z}_{u\_los 0}} \\ \frac{\partial {D}_{2}}{\partial {x}_{u}} & \frac{\partial {D}_{2}}{\partial {y}_{u}} & \frac{\partial {D}_{2}}{\partial {z}_{u}} & \frac{\partial {D}_{2}}{\partial {x}_{u\_los 0}} & \frac{\partial {D}_{2}}{\partial {y}_{u\_los 0}} & \frac{\partial {D}_{2}}{\partial {z}_{u\_los 0}} \\ \frac{\partial {D}_{3}}{\partial {x}_{u}} & \frac{\partial {D}_{3}}{\partial {y}_{u}} & \frac{\partial {D}_{3}}{\partial {z}_{u}} & \frac{\partial {D}_{3}}{\partial {x}_{u\_los 0}} & \frac{\partial {D}_{3}}{\partial {y}_{u\_los 0}} & \frac{\partial {D}_{3}}{\partial {z}_{u\_los 0}} \\ \frac{\partial {D}_{4}}{\partial {x}_{u}} & \frac{\partial {D}_{4}}{\partial {y}_{u}} & \frac{\partial {D}_{4}}{\partial {z}_{u}} & \frac{\partial {D}_{4}}{\partial {x}_{u\_los 0}} & \frac{\partial {D}_{4}}{\partial {y}_{u\_los 0}} & \frac{\partial {D}_{4}}{\partial {z}_{u\_los 0}} \\ \frac{\partial {D}_{5}}{\partial {x}_{u}} & \frac{\partial {D}_{5}}{\partial {y}_{u}} & \frac{\partial {D}_{5}}{\partial {z}_{u}} & \frac{\partial {D}_{5}}{\partial {x}_{u\_los 0}} & \frac{\partial {D}_{5}}{\partial {y}_{u\_los 0}} & \frac{\partial {D}_{5}}{\partial {z}_{u\_los 0}} \\ \frac{\partial {D}_{6}}{\partial {x}_{u}} & \frac{\partial {D}_{6}}{\partial {y}_{u}} & \frac{\partial {D}_{6}}{\partial {z}_{u}} & \frac{\partial {D}_{6}}{\partial {x}_{u\_los 0}} & \frac{\partial {D}_{6}}{\partial {y}_{u\_los 0}} & \frac{\partial {D}_{6}}{\partial {z}_{u\_los 0}}\end{matrix} ] ; \qquad ( 3 )$$

where, xᵤ, yᵤ and zᵤ respectively denote the coordinates of the target terminal MSk in the x, y and z directions, and xᵤ_{_}ₗₒₛ₀, yᵤ_{_}ₗₒₛ₀ and zᵤ_{_}ₗₒₛ₀ respectively denote coordinates of the terminal MS_LOS0 in the x, y and z directions.

In this embodiment, after the GDOP is calculated by using formulae (2) and (3), it is judged whether the GDOP is less than the predetermined first threshold value. And when the GDOP is less than the predetermined first threshold value, the terminal MS_LOS0 is taken as the selected at least one terminal.

In this embodiment, for the geometric distribution shown in FIG. 4, a similar method may be used to calculate the GDOP, which shall not be described herein any further.

In this embodiment, the first calculating unit 103 is configured to obtain location information on the target terminal and the at least one terminal by using a localization solution algorithm according to the information on the selected at least one terminal, the base stations on which LOS observation is capable of being performed by the at least one terminal, the target terminal and the base stations on which LOS observation is capable of being performed by the target terminal.

In this embodiment, the location information on the target terminal and the at least one terminal may be calculated by using an existing localization solution algorithm. For example, a maximum likelihood method or a least square method may be used for the calculation.

In this embodiment, exemplary description is given by taking that the least square method is used to calculate the location information on the target terminal and the at least one terminal as an example.

Following definitions are given to xᵤ, yᵤ, zᵤ, xᵤ_{_}ₗₒₛ₀, yᵤ_{_}ₗₒₛ₀ and zᵤ_{_}ₗₒₛ₀ in Formula (1):

xᵤ=x′ᵤ+Δxᵤ

yᵤ=y′ᵤ+Δyᵤ

zᵤ=z′ᵤ+Δzᵤ

xᵤ_{_}ₗₒₛ₀=x′ᵤ_{_}ₗₒₛ₀+Δxᵤ_{_}ₗₒₛ₀

yᵤ_{_}ₗₒₛ₀=y′ᵤ_{_}ₗₒₛ₀+Δyᵤ_{_}ₗₒₛ₀

zᵤ_{_}ₗₒₛ₀=z′ᵤ_{_}ₗₒₛ₀+Δzᵤ_{_}ₗₒₛ₀ (4).

First-order Taylor series expansion is performed on Formula (1) at (x′ᵤ,y′ᵤ,z′ᵤ,x′ᵤ_{_}ₗₒₛ₀,y′ᵤ_{_}ₗₒₛ₀,z′ᵤ_{_}ₗₒₛ₀), and a set of linearized equations expressed by Formula (5) below is obtained:

ΔD=H·ΔP (5);

where,

$$H = {[ \begin{matrix}\frac{\partial {D}_{1}}{\partial {x}_{u}} & \frac{\partial {D}_{1}}{\partial {y}_{u}} & \frac{\partial {D}_{1}}{\partial {z}_{u}} & \frac{\partial {D}_{1}}{\partial {x}_{u\_los 0}} & \frac{\partial {D}_{1}}{\partial {y}_{u\_los 0}} & \frac{\partial {D}_{1}}{\partial {z}_{u\_los 0}} \\ \frac{\partial {D}_{2}}{\partial {x}_{u}} & \frac{\partial {D}_{2}}{\partial {y}_{u}} & \frac{\partial {D}_{2}}{\partial {z}_{u}} & \frac{\partial {D}_{2}}{\partial {x}_{u\_los 0}} & \frac{\partial {D}_{2}}{\partial {y}_{u\_los 0}} & \frac{\partial {D}_{2}}{\partial {z}_{u\_los 0}} \\ \frac{\partial {D}_{3}}{\partial {x}_{u}} & \frac{\partial {D}_{3}}{\partial {y}_{u}} & \frac{\partial {D}_{3}}{\partial {z}_{u}} & \frac{\partial {D}_{3}}{\partial {x}_{u\_los 0}} & \frac{\partial {D}_{3}}{\partial {y}_{u\_los 0}} & \frac{\partial {D}_{3}}{\partial {z}_{u\_los 0}} \\ \frac{\partial {D}_{4}}{\partial {x}_{u}} & \frac{\partial {D}_{4}}{\partial {y}_{u}} & \frac{\partial {D}_{4}}{\partial {z}_{u}} & \frac{\partial {D}_{4}}{\partial {x}_{u\_los 0}} & \frac{\partial {D}_{4}}{\partial {y}_{u\_los 0}} & \frac{\partial {D}_{4}}{\partial {z}_{u\_los 0}} \\ \frac{\partial {D}_{5}}{\partial {x}_{u}} & \frac{\partial {D}_{5}}{\partial {y}_{u}} & \frac{\partial {D}_{5}}{\partial {z}_{u}} & \frac{\partial {D}_{5}}{\partial {x}_{u\_los 0}} & \frac{\partial {D}_{5}}{\partial {y}_{u\_los 0}} & \frac{\partial {D}_{5}}{\partial {z}_{u\_los 0}} \\ \frac{\partial {D}_{6}}{\partial {x}_{u}} & \frac{\partial {D}_{6}}{\partial {y}_{u}} & \frac{\partial {D}_{6}}{\partial {z}_{u}} & \frac{\partial {D}_{6}}{\partial {x}_{u\_los 0}} & \frac{\partial {D}_{6}}{\partial {y}_{u\_los 0}} & \frac{\partial {D}_{6}}{\partial {z}_{u\_los 0}}\end{matrix} ]}_{\begin{matrix}( \begin{matrix}{x}_{u} , {y}_{u} , {z}_{u} , \\ \begin{matrix}{x}_{u\_los 0} , \\ {y}_{u\_los 0} , {z}_{u\_los 0}\end{matrix}\end{matrix} ) = \\ ( \begin{matrix}{x}_{u}^{′} , {y}_{u}^{′} , {z}_{u}^{′} , \\ {x}_{u\_los 0}^{′} , {y}_{u\_los 0}^{′} , {z}_{u\_los 0}^{′}\end{matrix} )\end{matrix}} ,$$

ΔP=[Δxᵤ,Δyᵤ,Δzᵤ,Δxᵤ_{_}ₗₒₛ₀,Δyᵤ_{_}ₗₒₛ₀,Δzᵤ_{_}ₗₒₛ₀]^{T},

ΔD=[D₁−D′₁,D₂−D′₂,D₃−D′₃,D₄−D′₄,D₅−D′₅,D₆−D′₆]^{T},

D′ᵢ=\sqrt{(xᵢ−x′ᵤ)²+(yᵢ−y′ᵤ)²+(zᵢ−z′ᵤ)²}, i=1,2

D′ⱼ=\sqrt{(xⱼ−x′ᵤ_{_}ₗₒₛ₀)²+(yⱼ−y′ᵤ_{_}ₗₒₛ₀)²+(zⱼ−z′ᵤ_{_}ₗₒₛ₀)²}, j=3,4,5

D′₆=\sqrt{(x′ᵤ−x′ᵤ_{_}ₗₒₛ₀)²+(y′ᵤ−y′ᵤ_{_}ₗₒₛ₀)²+(z′ᵤ−z′ᵤ_{_}ₗₒₛ₀)²}

Least square estimation is performed on the set of linearized equations expressed by Formula (5), which may be expressed by Formula (6) below:

ΔP=(H^{T}·H)⁻¹·H^{T}·ΔD (6).

A calculation result obtained according to Formula (6) is used to update Formula (4), and the location information on the target terminal and the selected terminal may be obtained after multiple times of iteration, which is expressed by Formula (7) below:

P=[xᵤ,yᵤ,zᵤ,xᵤ_{_}ₗₒₛ₀,yᵤ_{_}ₗₒₛ₀,zᵤ_{_}ₗₒₛ₀]^{T} (7);

where, P denotes a transposed matrix of a coordinate matrix of the target terminal and the selected terminal, xᵤ, yᵤ and zᵤ respectively denote the coordinates of the target terminal MSk in the x, y and z directions, and xᵤ_{_}ₗₒₛ₀, yᵤ_{_}ₗₒₛ₀ and zᵤ_{_}ₗₒₛ₀ respectively denote coordinates of the terminal MS_LOS0 in the x, y and z directions.

In this embodiment, the apparatus may further include a first judging unit 104 and a second judging unit 105. The first judging unit 104 is configured to judge whether the number of the base stations on which LOS observation is capable of being performed by the target terminal is greater than or equal to a predetermined second threshold value, and second judging unit 105 is configured to judge whether GDOP of a geometric distribution constituted by the target terminal and the base stations on which LOS observation is capable of being performed by the target terminal is less than or equal to a predetermined third threshold value.

In this embodiment, the first judging unit 104 and the second judging unit 105 may be separately arranged in the apparatus 100, and may also be arrange in the determining unit 101, and positions of arrangement of the first judging unit and the second judging unit are not limited in this embodiment.

In this embodiment, the GDOP of the geometric distribution constituted by the target terminal and the base stations on which LOS observation is capable of being performed by the target terminal may be calculated by using an existing method. For example, it may be calculated by using Formula (2) above, which shall not be described herein any further.

In this embodiment, the second threshold value and the third threshold value may be set according to an actual situation. For example, the second threshold value is set to be an integer equal to or greater than 3, and the third threshold value is set to be a numeral value from 4 to 6.

In this embodiment, the determining unit 101 is configured to determine the terminals capable of performing LOS observation with the target terminal when the number of the base stations on which LOS observation is capable of being performed by the target terminal is less than the predetermined second threshold value, or the number of the base stations on which LOS observation is capable of being performed by the target terminal is greater than or equal to the predetermined second threshold value and the GDOP of the geometric distribution constituted by the target terminal and the base stations on which LOS observation is capable of being performed by the target terminal is greater than or equal to the predetermined third threshold value.

In this embodiment, the apparatus further includes:

a second calculating unit 106 configured to calculate the location information on the target terminal according to observation information on the base stations on which LOS observation is capable of being performed by the target terminal when the number of the base stations on which LOS observation is capable of being performed by the target terminal is greater than or equal to the predetermined second threshold value and the GDOP of the geometric distribution constituted by the target terminal and the base stations on which LOS observation is capable of being performed by the target terminal is less than the predetermined third threshold value.

In this embodiment, the first judging unit 104, the second judging unit 105 and the second calculating unit 106 are optional, which are shown in FIG. 1 in dashed boxes.

In this embodiment, the calculation of the location information on the target terminal according to the observation information on the base stations on which LOS observation is capable of being performed by the target terminal may use an existing method. For example, the location of the target terminal is estimated according to TOAs of the base stations on which LOS observation is capable of being performed by the target terminal.

Hence, when the location information on the target terminal can be calculated based on the base stations on which LOS observation is capable of being performed by the target terminal and the GDOP of the geometric distribution constituted by the target terminal and the base stations on which LOS observation is capable of being performed by the target terminal is less than the predetermined third threshold value, the location information on the target terminal can be calculated directly according to the base stations on which LOS observation is capable of being performed by the target terminal, which may simply and quickly perform localization the target terminal and ensure precision of the localization in a case where the geometric distribution constituted by the target terminal and the base stations on which LOS observation is capable of being performed by the target terminal is relatively good.

It can be seen from the above embodiment that positioning of the target terminal may be achieved without needing to preobtain a location of a terminal used for cooperative localization, and selection of the terminal used for cooperative localization according to the geometric distribution may efficiently improve the precision of the localization of the target terminal.

### Embodiment 2

An embodiment of the present disclosure further provides electronic equipment. FIG. 5 is a schematic diagram of a structure of the electronic equipment of Embodiment 2 of the present disclosure. As shown in FIG. 5, the electronic equipment 500 includes a localization apparatus 501. In this embodiment, a structure and functions of the localization apparatus 501 are identical to those described in Embodiment 1, and shall not be described herein any further.

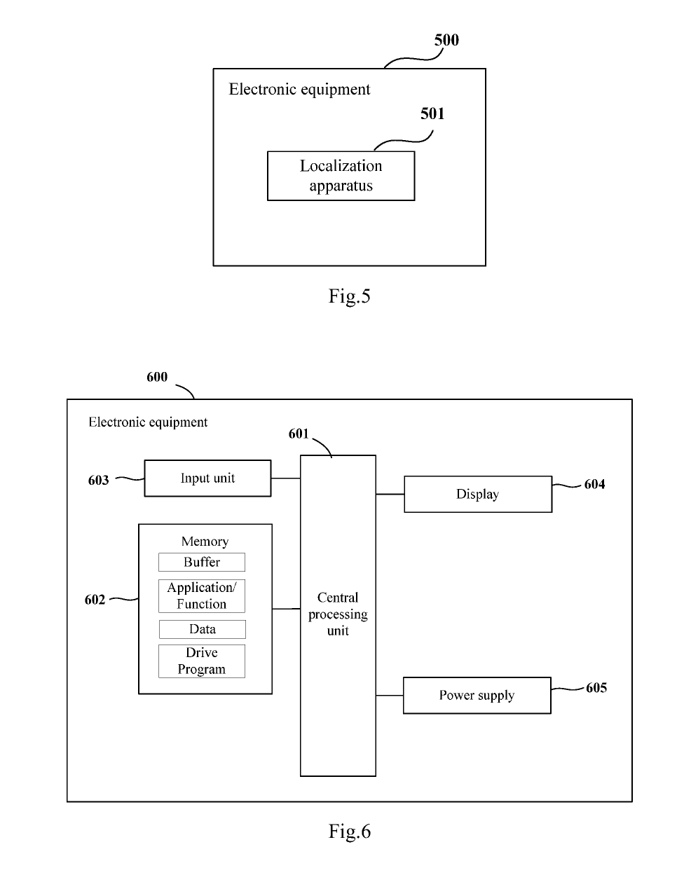

FIG. 6 is a block diagram of a systematic structure of the electronic equipment of Embodiment 2 of the present disclosure. As shown in FIG. 6, the electronic equipment 600 may include a central processing unit 601 and a memory 602, the memory 602 being coupled to the central processing unit 601. This figure is illustrative only, and other types of structures may also be used, so as to supplement or replace this structure and achieve telecommunications function or other functions. The electronic equipment may be equipment separately manufactured and used, and may also be a module integrated into a terminal or a base station.

As shown in FIG. 6, the electronic equipment 600 may further include an input unit 603, a display 604 and a power supply 605.

In an implementation, the function of the localization apparatus described in Embodiment 1 may be integrated into the central processing unit 601. In this embodiment, the central processing unit 601 may be configured to: determine terminals capable of performing LOS observation with a target terminal; select at least one terminal from the terminals capable of performing LOS observation with the target terminal, so that a geometric distribution constituted by the selected at least one terminal, base stations on which LOS observation is capable of being performed by the at least one terminal, the target terminal and base stations on which LOS observation is capable of being performed by the target terminal, satisfies a predetermined condition; and obtain location information on the target terminal and the selected at least one terminal by using a localization solution algorithm according to information on the selected at least one terminal, the base stations on which LOS observation is capable of being performed by the at least one terminal, the target terminal and the base stations on which LOS observation is capable of being performed by the target terminal.

In this embodiment, the predetermined condition includes that GDOP of the geometric distribution constituted by the selected at least one terminal, the base stations on which LOS observation is capable of being performed by the at least one terminal, the target terminal and the base stations on which LOS observation is capable of being performed by the target terminal is less than a predetermined first threshold value.

In this embodiment, the selecting at least one terminal from the terminals capable of performing LOS observation with the target terminal, so that a geometric distribution constituted by the selected at least one terminal, base stations on which LOS observation is capable of being performed by the at least one terminal, the target terminal and base stations on which LOS observation is capable of being performed by the target terminal, satisfies a predetermined condition, includes: judging in a descending order of the number of the base stations on which LOS observation is capable of being performed by the terminals whether the geometric distribution constituted by the terminal, the base stations on which LOS observation is capable of being performed by the terminal, the target terminal and the base stations on which LOS observation is capable of being performed by the target terminal satisfies the predetermined condition, and taking a terminal satisfying the predetermined condition as the selected at least one terminal.

In this embodiment, the determining terminals capable of performing LOS observation with a target terminal includes: determining the terminals capable of performing LOS observation with the target terminal when the number of the base stations on which LOS observation is capable of being performed by the target terminal is less than a predetermined second threshold value, or the number of the base stations on which LOS observation is capable of being performed by the target terminal is greater than or equal to the predetermined second threshold value and GDOP of a geometric distribution constituted by the target terminal and the base stations on which LOS observation is capable of being performed by the target terminal is greater than or equal to a predetermined third threshold value.

In this embodiment, the central processing unit 601 may further be configured to: calculate the location information on the target terminal according to observation information on the base stations on which LOS observation is capable of being performed by the target terminal when the number of the base stations on which LOS observation is capable of being performed by the target terminal is greater than or equal to the predetermined second threshold value and the GDOP of the geometric distribution constituted by the target terminal and the base stations on which LOS observation is capable of being performed by the target terminal is less than the predetermined third threshold value.

In this embodiment, information interacted between the target terminal and the terminals capable of performing LOS observation with the target terminal comprises at least one piece of the following information: information on base stations on which LOS observation is capable of being performed, coordinates of the base stations, observation information on a time of arrival (TOA) between the base stations and the terminals, location information on available terminals, information on terminals on which LOS observation is capable of being performed, ID information on terminals, and observation information on a TOA between terminals.

In another implementation, the localization apparatus described in Embodiment 1 and the central processing unit 601 may be configured separately. For example, the localization apparatus may be configured as a chip connected to the central processing unit 601, with its functions being realized under control of the central processing unit 601.

In this embodiment, the electronic equipment 600 does not necessarily include all the parts shown in FIG. 6.

As shown in FIG. 6, the central processing unit 601 is sometimes referred to as a controller or control, and may include a microprocessor or other processor devices and/or logic devices. The central processing unit 601 receives input and controls operations of every components of the electronic equipment 600.

The memory 602 may be, for example, one or more of a buffer memory, a flash memory, a hard drive, a mobile medium, a volatile memory, a nonvolatile memory, or other suitable devices. And the central processing unit 601 may execute the program stored in the memory 602, so as to realize information storage or processing, etc. Functions of other parts are similar to those of the related art, which shall not be described herein any further. The parts of the electronic equipment 600 may be realized by specific hardware, firmware, software, or any combination thereof, without departing from the scope of the present disclosure.

It can be seen from the above embodiment that positioning of the target terminal may be achieved without needing to preobtain a location of a terminal used for cooperative localization, and selection of the terminal used for cooperative localization according to the geometric distribution may efficiently improve the precision of the localization of the target terminal.

### Embodiment 3

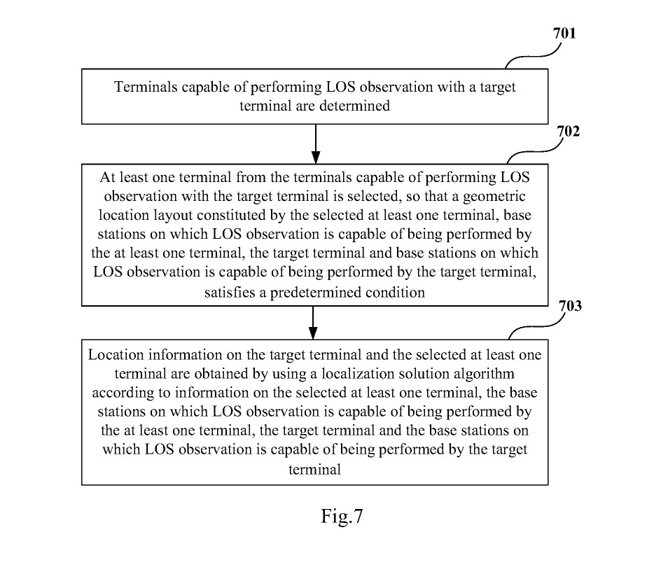

An embodiment of the present disclosure further provides a localization method, corresponding to the localization apparatus of Embodiment 1. FIG. 7 is a flowchart of the localization method of Embodiment 3 of the present disclosure. As shown in FIG. 7, the method includes:

Step 701: terminals capable of performing LOS observation with a target terminal are determined;

Step 702: at least one terminal from the terminals capable of performing LOS observation with the target terminal is selected, so that a geometric distribution constituted by the selected at least one terminal, base stations on which LOS observation is capable of being performed by the at least one terminal, the target terminal and base stations on which LOS observation is capable of being performed by the target terminal, satisfies a predetermined condition; and

Step 703: location information on the target terminal and the selected at least one terminal are obtained by using a localization solution algorithm according to information on the selected at least one terminal, the base stations on which LOS observation is capable of being performed by the at least one terminal, the target terminal and the base stations on which LOS observation is capable of being performed by the target terminal.

In this embodiment, the method for determining terminals capable of performing LOS observation with a target terminal, the method for selecting at least one terminal and the method for obtaining location information on the target terminal and the selected at least one terminal by using a localization solution algorithm are identical to those described in Embodiment 1, and shall not be described herein any further.

It can be seen from the above embodiment that positioning of the target terminal may be achieved without needing to preobtain a location of a terminal used for cooperative localization, and selection of the terminal used for cooperative localization according to the geometric distribution may efficiently improve the precision of the localization of the target terminal.

### Embodiment 4

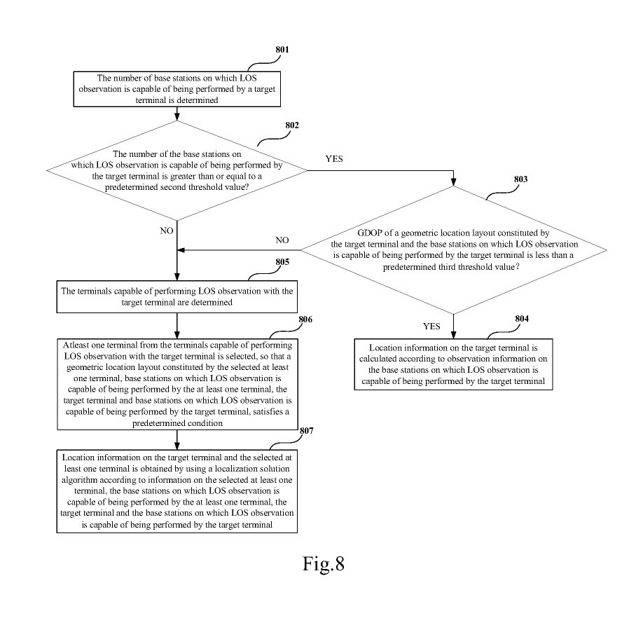

An embodiment of the present disclosure further provides a localization method, corresponding to the localization apparatus of Embodiment 1. FIG. 8 is a flowchart of the localization method of Embodiment 4 of the present disclosure. As shown in FIG. 8, the method includes:

Step 801: the number of base stations on which LOS observation is capable of being performed by a target terminal is determined;

Step 802: it is judged whether the number of the base stations on which LOS observation is capable of being performed by the target terminal is greater than or equal to a predetermined second threshold value, entering into step 803 when a result of judgment is “yes”, and entering into step 805 when the result of judgment is “no”;

Step 803: it is judged whether GDOP of a geometric distribution constituted by the target terminal and the base stations on which LOS observation is capable of being performed by the target terminal is less than a predetermined third threshold value, entering into step 804 when a result of judgment is “yes”, and entering into step 805 when the result of judgment is “no”;

Step 804: location information on the target terminal is calculated according to observation information on the base stations on which LOS observation is capable of being performed by the target terminal;

Step 805: the terminals capable of performing LOS observation with the target terminal are determined;

Step 806: at least one terminal from the terminals capable of performing LOS observation with the target terminal is selected, so that a geometric distribution constituted by the selected at least one terminal, base stations on which LOS observation is capable of being performed by the at least one terminal, the target terminal and base stations on which LOS observation is capable of being performed by the target terminal, satisfies a predetermined condition; and

Step 807: location information on the target terminal and the selected at least one terminal is obtained by using a localization solution algorithm according to information on the selected at least one terminal, the base stations on which LOS observation is capable of being performed by the at least one terminal, the target terminal and the base stations on which LOS observation is capable of being performed by the target terminal.

In this embodiment, the method for determining the number of base stations on which LOS observation is capable of being performed by a target terminal, the method for calculating the GDOP, the method for calculating location information on the target terminal according to observation information on the base stations on which LOS observation is capable of being performed by the target terminal, the method for determining the terminals capable of performing LOS observation with the target terminal, the method for selecting at least one terminal and the method for obtaining location information on the target terminal and the selected at least one terminal by using a localization solution algorithm are identical to those described in Embodiment 1, and shall not be described herein any further.

It can be seen from the above embodiment that positioning of the target terminal may be achieved without needing to preobtain a location of a terminal used for cooperative localization, and selection of the terminal used for cooperative localization according to the geometric distribution may efficiently improve the precision of the localization of the target terminal.

An embodiment of the present disclosure further provides a computer-readable program. When the program is executed in a localization apparatus or electronic equipment, the program enables the computer to carry out the localization method as described in Embodiment 3 or 4 in the localization apparatus or electronic equipment.

An embodiment of the present disclosure provides a storage medium in which a computer-readable program is stored. The computer-readable program enables the computer to carry out the localization method as described in Embodiment 3 or 4 in a localization apparatus or electronic equipment.

The above apparatuses and methods of the present disclosure may be implemented by hardware, or by hardware in combination with software. The present disclosure relates to such a computer-readable program that when the program is executed by a logic device, the logic device is enabled to carry out the apparatus or components as described above, or to carry out the methods or steps as described above. The present disclosure also relates to a storage medium for storing the above program, such as a hard disk, a floppy disk, a CD, a DVD, and a flash memory, etc.

The present disclosure is described above with reference to particular embodiments. However, it should be understood by those skilled in the art that such a description is illustrative only, and not intended to limit the protection scope of the present disclosure. Various variants and modifications may be made by those skilled in the art according to the principles of the present disclosure, and such variants and modifications fall within the scope of the present disclosure.

1. A localization apparatus, comprising:
a determining unit configured to determine terminals capable of performing line of sight (LOS) observation with a target terminal;
a selecting unit configured to select at least one terminal from the terminals capable of performing LOS observation with the target terminal, so that a geometric distribution constituted by the selected at least one terminal, base stations on which LOS observation is capable of being performed by the at least one terminal, the target terminal, and base stations on which LOS observation is capable of being performed by the target terminal, satisfies a predetermined condition; and
a first calculating unit configured to obtain location information on the target terminal and the selected at least one terminal by using a localization solution algorithm according to information on the selected at least one terminal, the base stations on which LOS observation is capable of being performed by the at least one terminal, the target terminal and the base stations on which LOS observation is capable of being performed by the target terminal.

2. The apparatus according to claim 1, wherein the predetermined condition comprises that geometric dilution of precision (GDOP) of the geometric distribution constituted by the selected at least one terminal, the base stations on which LOS observation is capable of being performed by the at least one terminal, the target terminal and the base stations on which LOS observation is capable of being performed by the target terminal is less than a predetermined first threshold value.

3. The apparatus according to claim 1, wherein the selecting unit is configured to judge in a descending order of the number of the base stations on which LOS observation is capable of being performed by the terminals whether the geometric distribution constituted by the terminal, the base stations on which LOS observation is capable of being performed by the terminal, the target terminal and the base stations on which LOS observation is capable of being performed by the target terminal satisfies the predetermined condition, and take a terminal satisfying the predetermined condition as the selected at least one terminal.

4. The apparatus according to claim 1, wherein,
the determining unit is configured to determine the terminals capable of performing LOS observation with the target terminal when the number of the base stations on which LOS observation is capable of being performed by the target terminal is less than a predetermined second threshold value, or the number of the base stations on which LOS observation is capable of being performed by the target terminal is greater than or equal to the predetermined second threshold value and GDOP of a geometric distribution constituted by the target terminal and the base stations on which LOS observation is capable of being performed by the target terminal is greater than or equal to a predetermined third threshold value.

5. The apparatus according to claim 4, wherein the apparatus further comprises:
a second calculating unit configured to calculate the location information on the target terminal according to observation information on the base stations on which LOS observation is capable of being performed by the target terminal when the number of the base stations on which LOS observation is capable of being performed by the target terminal is greater than or equal to the predetermined second threshold value and the GDOP of the geometric distribution constituted by the target terminal and the base stations on which LOS observation is capable of being performed by the target terminal is less than the predetermined third threshold value.

6. The apparatus according to claim 1, wherein information interacted between the target terminal and the terminals capable of performing LOS observation with the target terminal comprises at least one piece of the following information: information on base stations on which LOS observation is capable of being performed, coordinates of the base stations, observation information on a time of arrival (TOA) between the base stations and the terminals, location information on available terminals, information on terminals on which LOS observation is capable of being performed, ID information on terminals, and observation information on a TOA between terminals.

7. Electronic equipment, comprising the apparatus as claimed in claim 1.

8. A localization method, comprising:
determining terminals capable of performing LOS observation with a target terminal;
selecting at least one terminal from the terminals capable of performing LOS observation with the target terminal, so that a geometric distribution constituted by the selected at least one terminal, base stations on which LOS observation is capable of being performed by the at least one terminal, the target terminal and base stations on which LOS observation is capable of being performed by the target terminal, satisfies a predetermined condition; and
obtaining location information on the target terminal and the selected at least one terminal by using a localization solution algorithm according to information on the selected at least one terminal, the base stations on which LOS observation is capable of being performed by the at least one terminal, the target terminal and the base stations on which LOS observation is capable of being performed by the target terminal.

9. The method according to claim 8, wherein the predetermined condition comprises that GDOP of the geometric distribution constituted by the selected at least one terminal, the base stations on which LOS observation is capable of being performed by the at least one terminal, the target terminal and the base stations on which LOS observation is capable of being performed by the target terminal is less than a predetermined first threshold value.

10. The method according to claim 8, wherein the selecting at least one terminal from the terminals capable of performing LOS observation with the target terminal, so that a geometric distribution constituted by the selected at least one terminal, base stations on which LOS observation is capable of being performed by the at least one terminal, the target terminal and base stations on which LOS observation is capable of being performed by the target terminal, satisfies a predetermined condition, comprises:
judging in a descending order of the number of the base stations on which LOS observation is capable of being performed by the terminals whether the geometric distribution constituted by the terminal, the base stations on which LOS observation is capable of being performed by the terminal, the target terminal and the base stations on which LOS observation is capable of being performed by the target terminal satisfies the predetermined condition, and taking a terminal satisfying the predetermined condition as the selected at least one terminal.

11. The method according to claim 8, wherein the determining terminals capable of performing LOS observation with a target terminal includes:
determining the terminals capable of performing LOS observation with the target terminal when the number of the base stations on which LOS observation is capable of being performed by the target terminal is less than the predetermined second threshold value, or the number of the base stations on which LOS observation is capable of being performed by the target terminal is greater than or equal to the predetermined second threshold value and the GDOP of the geometric distribution constituted by the target terminal and the base stations on which LOS observation is capable of being performed by the target terminal is greater than or equal to the predetermined third threshold value.

12. The method according to claim 11, wherein the method further includes:
calculating the location information on the target terminal according to observation information on the base stations on which LOS observation is capable of being performed by the target terminal when the number of the base stations on which LOS observation is capable of being performed by the target terminal is greater than or equal to the predetermined second threshold value and the GDOP of the geometric distribution constituted by the target terminal and the base stations on which LOS observation is capable of being performed by the target terminal is less than the predetermined third threshold value.

13. The method according to claim 8, wherein information interacted between the target terminal and the terminals capable of performing LOS observation with the target terminal includes at least one piece of the following information: information on base stations on which LOS observation is capable of being performed, coordinates of the base stations, observation information on a time of arrival (TOA) between the base stations and the terminals, location information on available terminals, information on terminals on which LOS observation is capable of being performed, ID information on terminals, and observation information on a TOA between terminals.
